(19) United States
(12) Patent Application Publication
(10) Pub. No.: US 2023/0052334 A1
(43) Pub. Date: Feb. 16, 2023

(54) VOLTAGE CONTROL METHOD AND DEVICE FOR MOTOR

(71) Applicant: GREAT WALL MOTOR COMPANY LIMITED, Baoding City, Hebei (CN)

(72) Inventors: Yinlei WANG, Baoding City, Hebei (CN); Tong KANG, Baoding City, Hebei (CN); Wenchao LING, Baoding City, Hebei (CN); Baogang WANG, Baoding City, Hebei (CN); Weifeng DENG, Baoding City, Hebei (CN); Xiu LIU, Baoding City, Hebei (CN)

(21) Appl. No.: 17/790,155

(22) PCT Filed: Jan. 19, 2021
(86) PCT No.: PCT/CN2021/072670

§ 371 Date: Jun. 30, 2022

(30) Foreign Application Priority Data
Feb. 20, 2020 (CN) 202010105375.X

(51) Int. Cl. H02J 7/00; H02J 7/14

(52) U.S. Cl. CPC H02J 7/007184; H02J 7/007194; H02J 7/1492; F02N 11/0862

(57) ABSTRACT

The present disclosure provides a method and apparatus for controlling a voltage of an electric machine, applied to a vehicle having an electricity-generation-starting-up integrated electric machine, which relates to the technical field of vehicle controlling. The method includes: when the vehicle is in a voltage-controlling mode, acquiring a current battery voltage, a current battery electric current and an electric-current limit value of the vehicle; according to the battery voltage, determining an initial target voltage; according to a difference between the electric-current limit value and the battery electric current, determining a superposing-voltage value; based on the superposing-voltage value and the initial target voltage, determining a target controlling voltage; and based on the target controlling voltage, controlling the battery voltage of the vehicle.

The present application claims the priority of the Chinese patent application filed on Feb. 20, 2020 before the Chinese Patent Office with the application number of 202010105375.X and the title of “VOLTAGE CONTROL METHOD AND DEVICE FOR MOTOR”, which is incorporated herein in its entirety by reference.

### TECHNICAL FIELD

The present disclosure relates to the technical field of vehicle controlling, and particularly relates to a method and apparatus for controlling a voltage of an electric machine.

### BACKGROUND

With the gradual development of vehicle controlling technologies, for 48V micro hybrid electrical vehicles, the electric generators of conventional engines have been reformed by using an electricity-generation-starting-up integrated electric machine (Belt Driven Starter Generator, BSG), to form a belt-driven BSG.

Currently, the designed rotational speed of the BSGs is 0-15000 revolutions per minute, and the designed electric quantity of the 48V battery is 1.5 kilowatt-hours/hour. For vehicles equipped with a BSG, it is possible to include a mode in which the BSG generates electricity to charge the battery. Due to the BSG characteristic, the torque error is ±3 Nm when it within 100 Nm, and according to the power formula P=T*n/9550, wherein P represents the power, T represents the torque, and n represents the rotational speed, it can be known that the torque error causes a large power error in the high-rotational-speed zone.

The available battery electric quantity and the available power of 48V micro hybrid electrical vehicles are very low at a low temperature, and in this case the power error greatly affects the 48V battery, it results in over-charge or over-discharge of the battery, and also results in failure of the 48V battery and affection on the life of the 48V battery.

### SUMMARY

In view of the above, the present disclosure provides a method and apparatus for controlling a voltage of an electric machine, to solve the problems of the failure of 48V batteries and the affection on the life of 48V batteries.

In order to achieve the above object, the technical solutions of the present disclosure are realized as follows:

In the first aspect, an embodiment of the present disclosure provides a method for controlling a voltage of an electric machine, wherein the method is applied to a vehicle having an electricity-generation-starting-up integrated electric machine, and the method comprises:

when the vehicle is in a voltage-controlling mode, acquiring a current battery voltage, a current battery electric current and an electric-current limit value of the vehicle;

according to the battery voltage, determining an initial target voltage;

according to a difference between the electric-current limit value and the battery electric current, determining a superposing-voltage value;

based on the superposing-voltage value and the initial target voltage, determining a target controlling voltage; and

based on the target controlling voltage, controlling the battery voltage of the vehicle.

Optionally, before the step that when the vehicle is in the voltage-controlling mode, acquiring the current battery voltage, the current battery electric current and the electric-current limit value of the vehicle, the method further comprises:

when the vehicle satisfies a voltage-controlling activating condition, controlling the vehicle to enter the voltage-controlling mode.

Optionally, the step that based on the superposing-voltage value and the initial target voltage, determining the target controlling voltage, comprises:

superposing the superposing-voltage value to the initial target voltage one time every target preset duration, to obtain one instance of the target controlling voltage.

Optionally, the step that when the vehicle satisfies the voltage-controlling activating condition, controlling the vehicle to enter the voltage-controlling mode, comprises:

when the vehicle satisfies a condition that the electricity-generation-starting-up integrated electric machine is in a torque-controlling mode, a battery temperature is less than a first preset battery temperature, an engine rotational speed is greater than a first preset engine rotational speed and an entire vehicle has been in a preparation state for a duration greater than a preset duration, controlling the vehicle to enter the voltage-controlling mode.

Optionally, the step that based on the difference between the current electric current and the electric-current limit value of the battery, determining the superposing-voltage value, comprises:

if the difference between the current electric current and the electric-current limit value of the battery is greater than a maximum value of a preset difference range, calculating to obtain a positive superposing-voltage value;

if the difference between the current electric current and the electric-current limit value of the battery is within the preset difference range, setting the superposing-voltage value to be zero; and

if the difference between the current electric current and the electric-current limit value of the battery is less than a minimum value of the preset difference range, calculating to obtain a negative superposing-voltage value.

Optionally, after the step that based on the target controlling voltage, controlling the battery voltage of the vehicle, the method further comprises:

when the vehicle satisfies a condition that a battery temperature is greater than a second preset temperature and an engine rotational speed is less than a second preset engine rotational speed, controlling the vehicle to exit the voltage-controlling mode.

In the second aspect, an embodiment of the present disclosure provides an apparatus for controlling a voltage of an electric machine, wherein the apparatus is applied to a vehicle having an electricity-generation-starting-up integrated electric machine, and the apparatus comprises:

an acquiring module configured for, when the vehicle is in a voltage-controlling mode, acquiring a current battery voltage, a current battery electric current and an electric-current limit value of the vehicle;

a first determining module configured for, according to the battery voltage, determining an initial target voltage;

a second determining module configured for, according to a difference between the electric-current limit value and the battery electric current, determining a superposing-voltage value;

a third determining module configured for, based on the superposing-voltage value and the initial target voltage, determining a target controlling voltage; and

a first controlling module configured for, based on the target controlling voltage, controlling the battery voltage of the vehicle.

Optionally, the apparatus further comprises:

a second controlling module configured for, when the vehicle satisfies a voltage-controlling activating condition, controlling the vehicle to enter the voltage-controlling mode.

Optionally, the third determining module comprises:

an obtaining submodule configured for superposing the superposing-voltage value to the initial target voltage one time every target preset duration, to obtain one instance of the target controlling voltage.

Optionally, the second controlling module comprises:

a controlling submodule configured for, when the vehicle satisfies a condition that the electricity-generation-starting-up integrated electric machine is in a torque-controlling mode, a battery temperature is less than a first preset battery temperature, an engine rotational speed is greater than a first preset engine rotational speed and an entire vehicle has been in a preparation state for a duration greater than a preset duration, controlling the vehicle to enter the voltage-controlling mode.

Optionally, the second determining module comprises:

a first calculating submodule configured for, if the difference between the current electric current and the electric-current limit value of the battery is greater than a maximum value of a preset difference range, calculating to obtain a positive superposing-voltage value;

a setting submodule configured for, if the difference between the current electric current and the electric-current limit value of the battery is within the preset difference range, setting the superposing-voltage value to be zero; and

a second calculating submodule configured for, if the difference between the current electric current and the electric-current limit value of the battery is less than a minimum value of the preset difference range, calculating to obtain a negative superposing-voltage value.

Optionally, the apparatus further comprises:

a third controlling module configured for, when the vehicle satisfies a condition that a battery temperature is greater than a second preset temperature and an engine rotational speed is less than a second preset engine rotational speed, controlling the vehicle to exit the voltage-controlling mode.

As compared with the prior art, the embodiments of the present disclosure have the following advantages:

The method for controlling a voltage of an electric machine according to the embodiments of the present disclosure comprises, when the vehicle is in a voltage-controlling mode, acquiring a current battery voltage, a current battery electric current and an electric-current limit value of the vehicle; determining an initial target voltage according to the battery voltage; determining a superposing-voltage value according to a difference between the electric-current limit value and the battery electric current; determining a target controlling voltage based on the superposing-voltage value and the initial target voltage; and controlling the battery voltage of the vehicle based on the target controlling voltage. Accordingly, the vehicles can perform voltage-stabilization controlling by means of voltage superposition even if in conditions such as a low temperature, to merely charge the low-voltage loads and the 48V section, and not perform assisting discharging, which can precisely control the voltage, and prevent over-charge and over-discharge of the battery, thereby prolonging the life of the 48V battery.

The above description is merely a summary of the technical solutions of the present disclosure. In order to more clearly know the elements of the present disclosure to enable the implementation according to the contents of the description, and in order to make the above and other purposes, features and advantages of the present disclosure more apparent and understandable, the particular embodiments of the present disclosure are provided below.

### BRIEF DESCRIPTION OF THE DRAWINGS

In order to more clearly illustrate the technical solutions of the embodiments of the present disclosure or the prior art, the figures that are required to describe the embodiments or the prior art will be briefly introduced below. Apparently, the figures that are described below are embodiments of the present disclosure, and a person skilled in the art can obtain other figures according to these figures without paying creative work.

The drawings, which form part of the present disclosure, are intended to provide a further understanding of the present disclosure. The illustrative embodiments of the present disclosure and their explanation are intended to interpret the present disclosure, and do not inappropriately limit the present disclosure. In the drawings:

FIG. 1 shows a flow chart of the steps of the method for controlling a voltage of an electric machine according to the first embodiment of the present disclosure;

FIG. 2 shows a flow chart of the steps of the method for controlling a voltage of an electric machine according to the second embodiment of the present disclosure;

FIG. 3 shows a schematic structural diagram of the apparatus for controlling a voltage of an electric machine according to the third embodiment of the present disclosure;

FIG. 4 schematically shows a block diagram of a calculating and processing device for implementing the method according to the present disclosure; and

FIG. 5 schematically shows a storage unit for maintaining or carrying a program code for implementing the method according to the present disclosure.

### DETAILED DESCRIPTION

In order to make the objects, the technical solutions and the advantages of the embodiments of the present disclosure clearer, the technical solutions of the embodiments of the present disclosure will be clearly and completely described below with reference to the drawings of the embodiments of the present disclosure. Apparently, the described embodiments are merely certain embodiments of the present disclosure, rather than all of the embodiments. All of the other embodiments that a person skilled in the art obtains on the basis of the embodiments of the present disclosure without paying creative work fall within the protection scope of the present disclosure.

It should be noted that, subject to the avoiding of any conflict, the embodiments and the features of the embodiments of the present disclosure may be combined.

The present disclosure will be described in detail below with reference to the drawings and the embodiments.

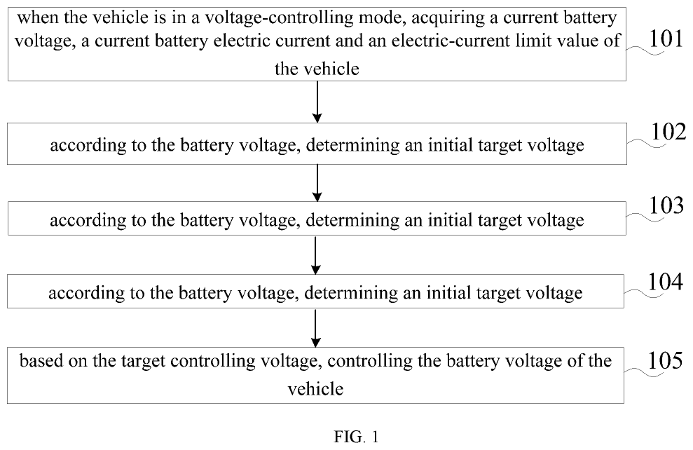

Referring to FIG. 1, a flow chart of the steps of the method for controlling a voltage of an electric machine according to the first embodiment of the present disclosure is shown. The method for controlling a voltage of an electric machine may be applied to a vehicle having an electricity-generation-starting-up integrated electric machine.

As shown in FIG. 1, the method for controlling a voltage of an electric machine may particularly comprise the following steps:

Step 101: when the vehicle is in a voltage-controlling mode, acquiring a current battery voltage, a current battery electric current and an electric-current limit value of the vehicle.

In an embodiment of the present disclosure, when the vehicle satisfies a condition that the electricity-generation-starting-up integrated electric machine is in a torque-controlling mode, a battery temperature is less than a first preset battery temperature, an engine rotational speed is greater than a first preset engine rotational speed and an entire vehicle has been in a preparation state for a duration greater than a preset duration, the vehicle may be controlled to enter the voltage-controlling mode. Certainly, the condition is not limited to that. In a particular implementation, the vehicle may also enter the single-pedal-function activating mode when the vehicle is in another condition, which may particularly be configured according to actual situations, and is not limited in the embodiments of the present disclosure.

The first preset battery temperature may be −26 degrees Celsius, and may also be −20 degrees Celsius. The first preset engine rotational speed may be 1400 revolutions per minute. The preset duration may be 5 seconds. All of those data are calibrationable data, which is not particularly limited in the embodiments of the present disclosure.

Optionally, when the vehicle is in the voltage-controlling mode, the entire-vehicle controlling unit (Hybrid Control Unit, HCU) of the vehicle receives the current battery voltage, the current battery electric current and the electric-current limit value of the vehicle that are emitted by the battery.

After the step that when the vehicle is in the voltage-controlling mode, acquiring the current battery voltage, the current battery electric current and the electric-current limit value of the vehicle, the step 102 is executed.

Step 102: according to the battery voltage, determining an initial target voltage.

The initial target voltage may be equal to the battery voltage plus a compensating value, wherein the range of the compensating value is (−0.5, +0.5). Certainly, the compensating value is not limited to that. In a particular implementation, the compensating value may be determined according to the actual calibration result, which may particularly be configured according to actual situations, and is not limited in the embodiments of the present disclosure.

After the step that according to the battery voltage, determining the initial target voltage, the step 103 is executed.

Step 103: according to a difference between the electric-current limit value and the battery electric current, determining a superposing-voltage value.

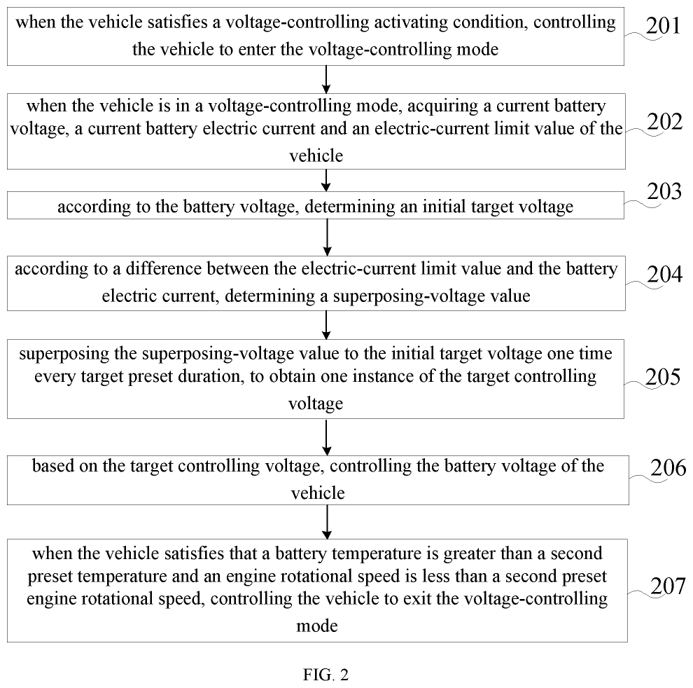

The HCU may determine a superposing-voltage value according to the difference between the electric-current limit value and the battery electric current, after calculating the difference between the current electric-current limit value and the battery electric current of the vehicle. As shown in FIG. 2, a correspondence relation between the difference between the electric-current limit value and the battery electric current and the superposing-voltage value according to an embodiment of the present disclosure is shown.

Correspondence relation between the difference between the electric-current limit value and the battery electric current and the superposing-voltage value

| | Difference/Ah | | | | | | | | | |
|---|---|---|---|---|---|---|---|---|---|---|
| | ≥100 | 80 | 60 | 40 | 30 | 15 | 13 | 10 | 7 | 5 |
| superposing-voltage value/V | 0.4 | 0.3 | 0.2 | 0.1 | 0 | 0 | −0.1 | −0.2 | −0.3 | −0.4 |

The correspondence relation between the difference between the electric-current limit value and the battery electric current and the superposing-voltage value may be pre-stored in the vehicle system, and, in turn, after the difference between the electric-current limit value and the battery electric current has been obtained by calculation, the superposing-voltage value corresponding to the difference may be determined according to the correspondence relation between the difference and the superposing-voltage value.

After the step that according to the difference between the electric-current limit value and the battery electric current, determining the superposing-voltage value, the step 104 is executed.

Step 104: based on the superposing-voltage value and the initial target voltage, determining a target controlling voltage.

The HCU may sum the superposing-voltage value and the initial target voltage after determining the superposing-voltage value, to obtain the target controlling voltage, and send the target controlling voltage to the BSG of the vehicle. Furthermore, the step 105 may be executed according to the target controlling voltage in the BSG of the vehicle.

Step 105: based on the target controlling voltage, controlling the battery voltage of the vehicle.

The BSG of the vehicle receives the target controlling voltage emitted by the HCU, to control the battery voltage of the vehicle. The controlling precision is within ±1V, and can self-adaptively change, and the controlled voltage is stable.

The method for controlling a voltage of an electric machine according to the embodiments of the present disclosure comprises, when the vehicle is in a voltage-controlling mode, acquiring a current battery voltage, a current battery electric current and an electric-current limit value of the vehicle; determining an initial target voltage according to the battery voltage; determining a superposing-voltage value according to a difference between the electric-current limit value and the battery electric current; determining a target controlling voltage based on the superposing-voltage value and the initial target voltage; and controlling the battery voltage of the vehicle based on the target controlling voltage. Accordingly, the vehicle can perform voltage-stabilization controlling by means of voltage superposition even if in conditions such as a low temperature, to merely charge the low-voltage loads and the 48V section, and not perform assisting discharging, which can precisely control the voltage, and prevent over-charge and over-discharge of the battery, thereby prolonging the life of the 48V battery.

Referring to FIG. 2, a flow chart of the steps of the method for controlling a voltage of an electric machine according to the second embodiment of the present disclosure is shown. The method for controlling a voltage of an electric machine is applied to a vehicle having an electricity-generation-starting-up integrated electric machine.

As shown in FIG. 2, the method for controlling a voltage of an electric machine may particularly comprise the following steps:

Step 201: when the vehicle satisfies a voltage-controlling activating condition, controlling the vehicle to enter the voltage-controlling mode.

In an embodiment of the present disclosure, the particular implementation process of the step 201 may comprise:

When the vehicle satisfies a condition that the electricity-generation-starting-up integrated electric machine is in a torque-controlling mode, a battery temperature is less than a first preset battery temperature, an engine rotational speed is greater than a first preset engine rotational speed and an entire vehicle has been in a preparation state for a duration greater than a preset duration, the vehicle may be controlled to enter the voltage-controlling mode. Certainly, the condition is not limited to that. In a particular implementation, the vehicle may also enter the single-pedal-function activating mode when the vehicle is in another condition, which may particularly be configured according to actual situations, and is not limited in the embodiments of the present disclosure.

The first preset battery temperature may be −26 degrees Celsius, and may also be −20 degrees Celsius. The first preset engine rotational speed may be 1400 revolutions per minute. The preset duration may be 5 seconds. All of those data are calibrationable data, which is not particularly limited in the embodiments of the present disclosure.

After the step that when the vehicle satisfies the voltage-controlling activating condition, controlling the vehicle to enter the voltage-controlling mode, the step 202 is executed.

Step 202: when the vehicle is in a voltage-controlling mode, acquiring a current battery voltage, a current battery electric current and an electric-current limit value of the vehicle.

Optionally, when the vehicle is in the voltage-controlling mode, the entire-vehicle controlling unit of the vehicle receives the current battery voltage, the current battery electric current and the electric-current limit value of the vehicle that are emitted by the battery.

After the step that when the vehicle is in the voltage-controlling mode, acquiring the current battery voltage, the current battery electric current and the electric-current limit value of the vehicle, the step 203 is executed.

Step 203: according to the battery voltage, determining an initial target voltage.

The initial target voltage may be the battery voltage plus a compensating value, wherein the range of the compensating value is (−0.5, +0.5). Certainly, the compensating value is not limited to that. In a particular implementation, the compensating value may be determined according to the actual calibration result, which may particularly be configured according to actual situations, and is not limited in the embodiments of the present disclosure.

After the step that according to the battery voltage, determining the initial target voltage, the step 204 is executed.

Step 204: according to a difference between the electric-current limit value and the battery electric current, determining a superposing-voltage value.

In an embodiment of the present disclosure, the HCU may determine a superposing-voltage value according to the difference between the electric-current limit value and the battery electric current after acquiring the difference between the current electric-current limit value and the battery electric current of the vehicle. As shown in FIG. 2, a correspondence relation between the difference between the electric-current limit value and the battery electric current and the superposing-voltage value according to an embodiment of the present disclosure is shown.

Correspondence relation between the difference between the electric-current limit value and the battery electric current and the superposing-voltage value

| | Difference/Ah | | | | | | | | | |
|---|---|---|---|---|---|---|---|---|---|---|
| | ≥100 | 80 | 60 | 40 | 30 | 15 | 13 | 10 | 7 | 5 |
| superposing-voltage value/V | 0.4 | 0.3 | 0.2 | 0.1 | 0 | 0 | −0.1 | −0.2 | −0.3 | −0.4 |

The correspondence relation between the difference between the electric-current limit value and the battery electric current and the superposing-voltage value may be pre-stored in the vehicle system, and, in turn, after the difference between the electric-current limit value and the battery electric current has been obtained by calculation, the superposing-voltage value corresponding to the difference may be determined according to the correspondence relation between the difference and the superposing-voltage value.

In an embodiment of the present disclosure, the particular implementation process of the step 204 may comprise:

Sub-step 2041: if the difference between the current electric current and the electric-current limit value of the battery is greater than a maximum value of a preset difference range, calculating to obtain a positive superposing-voltage value.

Optionally, the preset difference range may be (15,30)Ah, and, accordingly, when the difference between the current electric current and the electric-current limit value of the battery is greater than 30 Ah, referring to the above table, a corresponding positive superposing-voltage value can be obtained. For example, when the difference is 40 Ah, the superposing-voltage value is 0.1. When the difference is 60 Ah, the superposing-voltage value is 0.2. When the difference is 80 Ah, the superposing-voltage value is 0.3, and so on.

Sub-step 2042: if the difference between the current electric current and the electric-current limit value of the battery is within the preset difference range, setting the superposing-voltage value to be zero.

Optionally, the preset difference range may be (15,30)Ah, and, accordingly, when the difference between the current electric current and the electric-current limit value of the battery is within (15,30)Ah, the superposing-voltage value is 0.

Sub-step 2043: if the difference between the current electric current and the electric-current limit value of the battery is less than a minimum value of the preset difference range, calculating to obtain a negative superposing-voltage value.

Optionally, the preset difference range may be (15,30)Ah, and, accordingly, when the difference between the current electric current and the electric-current limit value of the battery is less than 30 Ah, referring to the above table, a corresponding negative superposing-voltage value can be obtained. For example, when the difference is 13 Ah, the superposing-voltage value is −0.1. When the difference is 10 Ah, the superposing-voltage value is −0.2. When the difference is 70 Ah, the superposing-voltage value is −0.3, and so on.

It should be noted that, when the difference between the current electric current and the electric-current limit value of the battery is less than a preset critical value, the initial voltage of the battery is used as the target controlling voltage, and the superposition begins when the difference between the current electric current and the electric-current limit value of the battery is greater than a maximum value of a preset difference range.

The preset critical value may be set to be 5 Ah, which is not particularly limited in the embodiments of the present disclosure.

After the step that according to the difference between the electric-current limit value and the battery electric current, determining the superposing-voltage value, the step 205 is executed.

Step 205: superposing the superposing-voltage value to the initial target voltage one time every target preset duration, to obtain one instance of the target controlling voltage.

The HCU may sum the superposing-voltage value and the initial target voltage after determining the superposing-voltage value, to obtain the target controlling voltage, wherein in the process the target voltage may be superposed one time every 5 seconds, to obtain the real-time target controlling voltage, and send the target controlling voltage to the BSG of the vehicle. Furthermore, the step 206 may be executed according to the target controlling voltage in the BSG of the vehicle.

Step 206: based on the target controlling voltage, controlling the battery voltage of the vehicle.

The BSG of the vehicle receives the target controlling voltage emitted by the HCU, to control the battery voltage of the vehicle. The controlling precision is within ±1V, and can self-adaptively change, and the controlled voltage is stable.

It should be noted that, after the vehicle has entered the voltage-controlling mode, the BSG merely performs the function of charging and supplies electric power to the low-voltage loads according to the target controlling voltage of the battery at the moment, does not perform the assisting and charging functions in the conventional torque mode, and performs voltage-stabilization controlling in the form of an electric generator with the target controlling voltage as the target. If the target controlling voltage is equal to the voltage of the 48V battery, then the BSG cannot charge the 48V battery, merely serves as an external parallel-connected voltage source, and is merely used by a device for conversion between high- and low-voltage direct currents (Direct Current Direct Current, DCDC) to convert a direct current (DC) into a 12V load. With the changing of the 12V low-voltage loads (a large lamp, a fan, and so on), the BSG self-adapts for the changing in the loads, to ensure that the voltage outputted by the BSG is stable.

After the step that based on the target controlling voltage, controlling the battery voltage of the vehicle, the step 207 is executed.

Step 207: when the vehicle satisfies a condition that a battery temperature is greater than a second preset temperature and an engine rotational speed is less than a second preset engine rotational speed, controlling the vehicle to exit the voltage-controlling mode.

The second preset temperature may be −24 degrees Celsius, and the second preset engine rotational speed may be 800 revolutions per minute.

The method for controlling a voltage of an electric machine according to the embodiments of the present disclosure comprises, when the vehicle satisfies a voltage-controlling activating condition, controlling the vehicle to enter the voltage-controlling mode; when the vehicle is in a voltage-controlling mode, acquiring a current battery voltage, a current battery electric current and an electric-current limit value of the vehicle; determining an initial target voltage according to the battery voltage; determining a superposing-voltage value according to a difference between the electric-current limit value and the battery electric current; superposing the superposing-voltage value to the initial target voltage one time every target preset duration, to obtain one instance of the target controlling voltage; controlling the battery voltage of the vehicle based on the target controlling voltage; and when the vehicle satisfies a condition that a battery temperature is greater than a second preset temperature and an engine rotational speed is less than a second preset engine rotational speed, controlling the vehicle to exit the voltage-controlling mode. Accordingly, the vehicle can perform voltage-stabilization controlling by means of voltage superposition even if in conditions such as a low temperature, to merely charge the low-voltage loads and the 48V section, and not perform assisting discharging, which can precisely control the voltage, and prevent over-charge and over-discharge of the battery, thereby prolonging the life of the 48V battery.

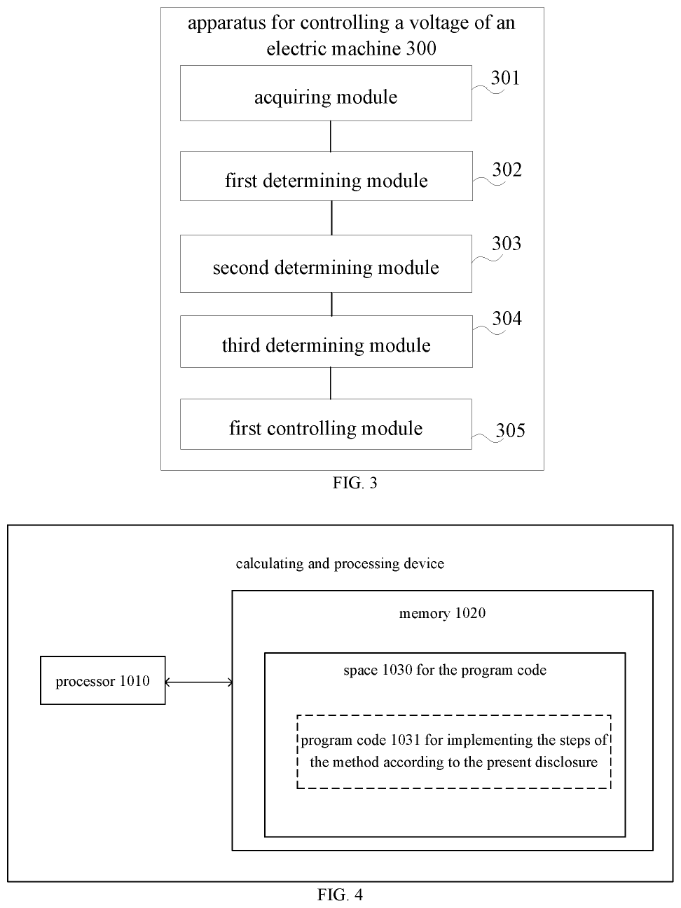

Referring to FIG. 3, a schematic structural diagram of the apparatus for controlling a voltage of an electric machine according to the third embodiment of the present disclosure is shown. The apparatus for controlling a voltage of an electric machine is applied to a vehicle having an electricity-generation-starting-up integrated electric machine.

As shown in FIG. 3, the apparatus for controlling a voltage of an electric machine 300 may particularly comprise:

an acquiring module 301 configured for, when the vehicle is in a voltage-controlling mode, acquiring a current battery voltage, a current battery electric current and an electric-current limit value of the vehicle;

a first determining module 302 configured for, according to the battery voltage, determining an initial target voltage;

a second determining module 303 configured for, according to a difference between the electric-current limit value and the battery electric current, determining a superposing-voltage value;

a third determining module 304 configured for, based on the superposing-voltage value and the initial target voltage, determining a target controlling voltage; and

a first controlling module 305 configured for, based on the target controlling voltage, controlling the battery voltage of the vehicle.

Optionally, the apparatus further comprises:

a second controlling module configured for, when the vehicle satisfies a voltage-controlling activating condition, controlling the vehicle to enter the voltage-controlling mode.

Optionally, the third determining module comprises:

an obtaining submodule configured for superposing the superposing-voltage value to the initial target voltage one time every target preset duration, to obtain one instance of the target controlling voltage.

Optionally, the second controlling module comprises:

a controlling submodule configured for, when the vehicle satisfies a condition that the electricity-generation-starting-up integrated electric machine is in a torque-controlling mode, a battery temperature is less than a first preset battery temperature, an engine rotational speed is greater than a first preset engine rotational speed and an entire vehicle has been in a preparation state for a duration greater than a preset duration, controlling the vehicle to enter the voltage-controlling mode.

Optionally, the second determining module comprises:

a first calculating submodule configured for, if the difference between the current electric current and the electric-current limit value of the battery is greater than a maximum value of a preset difference range, calculating to obtain a positive superposing-voltage value;

a setting submodule configured for, if the difference between the current electric current and the electric-current limit value of the battery is within the preset difference range, setting the superposing-voltage value to be zero; and

a second calculating submodule configured for, if the difference between the current electric current and the electric-current limit value of the battery is less than a minimum value of the preset difference range, calculating to obtain a negative superposing-voltage value.

Optionally, the apparatus further comprises:

a third controlling module configured for, when the vehicle satisfies that a battery temperature is greater than a second preset temperature and an engine rotational speed is less than a second preset engine rotational speed, controlling the vehicle to exit the voltage-controlling mode.

The particular implementations of the apparatus for controlling a voltage of an electric machine according to the embodiments of the present disclosure have already been described in detail in the process section, and are not discussed herein further.

The method for controlling a voltage of an electric machine according to the embodiments of the present disclosure can, by using the acquiring module, when the vehicle is in a voltage-controlling mode, acquire a current battery voltage, a current battery electric current and an electric-current limit value of the vehicle; by using the first determining module, determine an initial target voltage according to the battery voltage; by using the second determining module, determine a superposing-voltage value according to a difference between the electric-current limit value and the battery electric current; by using the third determining module, determine a target controlling voltage based on the superposing-voltage value and the initial target voltage; and finally, by using the first controlling module, control the battery voltage of the vehicle based on the target controlling voltage. Accordingly, the vehicle can perform voltage-stabilization controlling by means of voltage superposition even if in conditions such as a low temperature, to merely charge the low-voltage loads and the 48V section, and not perform assisting discharging, which can precisely control the voltage, and prevent over-charge and over-discharge of the battery, thereby prolonging the life of the 48V battery.

The above description is merely preferable embodiments of the present disclosure, and is not indented to limit the present disclosure. Any modifications, equivalent substitutions and improvements that are made within the spirit and the principle of the present disclosure should fall within the protection scope of the present disclosure.

The above-described device embodiments are merely illustrative, wherein the units that are described as separate components may or may not be physically separate, and the components that are displayed as units may or may not be physical units; in other words, they may be located at the same one location, and may also be distributed to a plurality of network units. Some or all of the modules may be selected according to the actual demands to realize the purposes of the solutions of the embodiments. A person skilled in the art can understand and implement the technical solutions without paying creative work.

Each component embodiment of the present disclosure may be implemented by hardware, or by software modules that are operated on one or more processors, or by a combination thereof. A person skilled in the art should understand that some or all of the functions of some or all of the components of the calculating and processing device according to the embodiments of the present disclosure may be implemented by using a microprocessor or a digital signal processor (DSP) in practice. The present disclosure may also be implemented as apparatus or device programs (for example, computer programs and computer program products) for implementing part of or the whole of the method described herein. Such programs for implementing the present disclosure may be stored in a computer-readable medium, or may be in the form of one or more signals. Such signals may be downloaded from an Internet website, or provided on a carrier signal, or provided in any other forms.

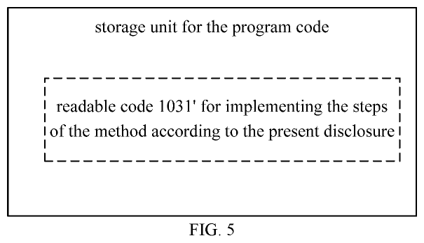

For example, FIG. 4 shows a calculating and processing device that can implement the method according to the present disclosure. The calculating and processing device traditionally comprises a processor 1010 and a computer program product or computer-readable medium in the form of a memory 1020. The memory 1020 may be electronic memories such as flash memory, EEPROM (Electrically Erasable Programmable Read Only Memory), EPROM, hard disk or ROM. The memory 1020 has the storage space 1030 of the program code 1031 for implementing any steps of the above method. For example, the storage space 1030 for program code may contain program codes 1031 for individually implementing each of the steps of the above method. Those program codes may be read from one or more computer program products or be written into the one or more computer program products. Those computer program products include program code carriers such as a hard disk, a compact disk (CD), a memory card or a floppy disk. Such computer program products are usually portable or fixed storage units as shown in FIG. 5. The storage unit may have storage segments or storage spaces with similar arrangement to the memory 1020 of the calculating and processing device in FIG. 4. The program codes may, for example, be compressed in a suitable form. Generally, the storage unit contains a computer-readable code 1031′, which can be read by a processor like 1010. When those codes are executed by the calculating and processing device, the codes cause the calculating and processing device to implement each of the steps of the method described above.

The “one embodiment”, “an embodiment” or “one or more embodiments” as used herein means that particular features, structures or characteristics described with reference to an embodiment are included in at least one embodiment of the present disclosure. Moreover, it should be noted that here an example using the wording “in an embodiment” does not necessarily refer to the same one embodiment.

The description provided herein describes many concrete details. However, it can be understood that the embodiments of the present disclosure may be implemented without those concrete details. In some of the embodiments, well-known processes, structures and techniques are not described in detail, so as not to affect the understanding of the description.

In the claims, any reference signs between parentheses should not be construed as limiting the claims. The word “comprise” does not exclude elements or steps that are not listed in the claims. The word “a” or “an” preceding an element does not exclude the existing of a plurality of such elements. The present disclosure may be implemented by means of hardware comprising several different elements and by means of a properly programmed computer. In unit claims that list several devices, some of those devices may be embodied by the same item of hardware. The words first, second, third and so on do not denote any order. Those words may be interpreted as names.

Finally, it should be noted that the above embodiments are merely intended to explain the technical solutions of the present disclosure, and not to limit them. Although the present disclosure is explained in detail with reference to the above embodiments, a person skilled in the art should understand that he can still modify the technical solutions set forth by the above embodiments, or make equivalent substitutions to part of the technical features of them. However, those modifications or substitutions do not make the essence of the corresponding technical solutions depart from the spirit and scope of the technical solutions of the embodiments of the present disclosure.

1. A method for controlling a voltage of an electric machine, wherein the method is applied to a vehicle having an electricity-generation-starting-up integrated electric machine, and the method comprises:
when the vehicle is in a voltage-controlling mode, acquiring, by one or more processors, a current battery voltage, a current battery electric current and an electric-current limit value of the vehicle;
according to the battery voltage, determining, by one or more processors, an initial target voltage;
according to a difference between the electric-current limit value and the battery electric current, determining, by one or more processors, a superposing-voltage value;
based on the superposing-voltage value and the initial target voltage, determining, by one or more processors, a target controlling voltage; and
based on the target controlling voltage, controlling, by one or more processors, the battery voltage of the vehicle.

2. The method according to claim 1, wherein before the step that when the vehicle is in the voltage-controlling mode, acquiring, by one or more processors, the current battery voltage, the current battery electric current and the electric-current limit value of the vehicle, the method further comprises:
when the vehicle satisfies a voltage-controlling activating condition, controlling the vehicle to enter the voltage-controlling mode.

3. The method according to claim 1, wherein the step that based on the superposing-voltage value and the initial target voltage, determining, by one or more processors, the target controlling voltage, comprises:
superposing the superposing-voltage value to the initial target voltage one time every target preset duration, to obtain one instance of the target controlling voltage.

4. The method according to claim 2, wherein the step that when the vehicle satisfies the voltage-controlling activating condition, controlling the vehicle to enter the voltage-controlling mode, comprises:
when the vehicle satisfies a condition that the electricity-generation-starting-up integrated electric machine is in a torque-controlling mode, a battery temperature is less than a first preset battery temperature, an engine rotational speed is greater than a first preset engine rotational speed and an entire vehicle has been in a preparation state for a duration greater than a preset duration, controlling the vehicle to enter the voltage-controlling mode.

5. The method according to claim 1, wherein the step that based on the difference between the current electric current and the electric-current limit value of the battery, determining, by one or more processors, the superposing-voltage value, comprises:
if the difference between the current electric current and the electric-current limit value of the battery is greater than a maximum value of a preset difference range, calculating to obtain a positive superposing-voltage value;
if the difference between the current electric current and the electric-current limit value of the battery is within the preset difference range, setting the superposing-voltage value to be zero; and
if the difference between the current electric current and the electric-current limit value of the battery is less than a minimum value of the preset difference range, calculating to obtain a negative superposing-voltage value.

6. The method according to claim 1, wherein after the step that based on the target controlling voltage, controlling, by one or more processors, the battery voltage of the vehicle, the method further comprises:
when the vehicle satisfies a condition that a battery temperature is greater than a second preset temperature and an engine rotational speed is less than a second preset engine rotational speed, controlling the vehicle to exit the voltage-controlling mode.

7. A system for controlling a voltage of an electric machine, wherein the apparatus is applied to a vehicle having an electricity-generation-starting-up integrated electric machine, and the system comprises:
one or more processors and a storage apparatus; and
the storage apparatus stores a computer program, when the computer program is executed by the processor, the system performs the operations comprising:
when the vehicle is in a voltage-controlling mode, acquiring a current battery voltage, a current battery electric current and an electric-current limit value of the vehicle;
according to the battery voltage, determining an initial target voltage;
according to a difference between the electric-current limit value and the battery electric current, determining a superposing-voltage value;
based on the superposing-voltage value and the initial target voltage, determining a target controlling voltage; and
based on the target controlling voltage, controlling the battery voltage of the vehicle.

8. The system according to claim 7, wherein the operations performed by the system further comprise:
when the vehicle satisfies a voltage-controlling activating condition, controlling the vehicle to enter the voltage-controlling mode.

9. The system according to claim 7, wherein the operations performed by the system further comprise:
superposing the superposing-voltage value to the initial target voltage one time every target preset duration, to obtain one instance of the target controlling voltage.

10. The system according to claim 8, wherein the operations performed by the system further comprise:
when the vehicle satisfies a condition that the electricity-generation-starting-up integrated electric machine is in a torque-controlling mode, a battery temperature is less than a first preset battery temperature, an engine rotational speed is greater than a first preset engine rotational speed and an entire vehicle has been in a preparation state for a duration greater than a preset duration, controlling the vehicle to enter the voltage-controlling mode.

11. The system according to claim 7, wherein the operations performed by the system further comprise:
if the difference between the current electric current and the electric-current limit value of the battery is greater than a maximum value of a preset difference range, calculating to obtain a positive superposing-voltage value;
if the difference between the current electric current and the electric-current limit value of the battery is within the preset difference range, setting the superposing-voltage value to be zero; and
if the difference between the current electric current and the electric-current limit value of the battery is less than a minimum value of the preset difference range, calculating to obtain a negative superposing-voltage value.

12. The system according to claim 7, wherein the operations performed by the system further comprise:
when the vehicle satisfies a condition that a battery temperature is greater than a second preset temperature and an engine rotational speed is less than a second preset engine rotational speed, controlling the vehicle to exit the voltage-controlling mode.

13. A calculating and processing device, wherein the calculating and processing device comprises:
a memory storing a computer-readable code; and
one or more processors, wherein when the computer-readable code is executed by the one or more processors, the calculating and processing device implements a method for controlling a voltage of an electric machine applied to a vehicle having an electricity-generation-starting-up integrated electric machine, and the method comprises:
when the vehicle is in a voltage-controlling mode, acquiring a current battery voltage, a current battery electric current and an electric-current limit value of the vehicle;
according to the battery voltage, determining an initial target voltage;
according to a difference between the electric-current limit value and the battery electric current, determining a superposing-voltage value;
based on the superposing-voltage value and the initial target voltage, determining a target controlling voltage; and
based on the target controlling voltage, controlling the battery voltage of the vehicle.

14. (canceled)

15. A computer-readable medium, wherein the computer-readable medium stores a computer-readable code, and when the computer-readable code is executed, the method for controlling a voltage of an electric machine according to claim 1 is performed.

16. The calculating and processing device according to claim 13, wherein before the step that when the vehicle is in the voltage-controlling mode, acquiring the current battery voltage, the current battery electric current and the electric-current limit value of the vehicle, the method further comprises:
when the vehicle satisfies a voltage-controlling activating condition, controlling the vehicle to enter the voltage-controlling mode.

17. The calculating and processing device according to claim 13, wherein the step that based on the superposing-voltage value and the initial target voltage, determining the target controlling voltage, comprises:
superposing the superposing-voltage value to the initial target voltage one time every target preset duration, to obtain one instance of the target controlling voltage.

18. The calculating and processing device according to claim 13, wherein the step that when the vehicle satisfies the voltage-controlling activating condition, controlling the vehicle to enter the voltage-controlling mode, comprises:
when the vehicle satisfies a condition that the electricity-generation-starting-up integrated electric machine is in a torque-controlling mode, a battery temperature is less than a first preset battery temperature, an engine rotational speed is greater than a first preset engine rotational speed and an entire vehicle has been in a preparation state for a duration greater than a preset duration, controlling the vehicle to enter the voltage-controlling mode.

19. The calculating and processing device according to claim 13, wherein the step that based on the difference between the current electric current and the electric-current limit value of the battery, determining the superposing-voltage value, comprises:
if the difference between the current electric current and the electric-current limit value of the battery is greater than a maximum value of a preset difference range, calculating to obtain a positive superposing-voltage value;
if the difference between the current electric current and the electric-current limit value of the battery is within the preset difference range, setting the superposing-voltage value to be zero; and
if the difference between the current electric current and the electric-current limit value of the battery is less than a minimum value of the preset difference range, calculating to obtain a negative superposing-voltage value.

20. The calculating and processing device according to claim 13, wherein after the step that based on the target controlling voltage, controlling the battery voltage of the vehicle, the method further comprises:
when the vehicle satisfies a condition that a battery temperature is greater than a second preset temperature and an engine rotational speed is less than a second preset engine rotational speed, controlling the vehicle to exit the voltage-controlling mode.
